(19) United States
(12) Patent Application Publication
(10) Pub. No.: US 2025/0079607 A1
(43) Pub. Date: Mar. 6, 2025

(54) METHOD FOR PRODUCING BATTERY PACK AND BATTERY PACK

(71) Applicant: TOYOTA JIDOSHA KABUSHIKI KAISHA, Toyota-shi (JP)

(72) Inventor: Shotaro ISHIKAWA, Miyoshi-shi (JP)

(73) Assignee: TOYOTA JIDOSHA KABUSHIKI KAISHA, Toyota-shi (JP)

(21) Appl. No.: 18/804,519

(22) Filed: Aug. 14, 2024

(30) Foreign Application Priority Data
Aug. 29, 2023 (JP) 2023138678

(51) Int. Cl. H01M 50/244; C09J 5/06; C09J 11/04; H01M 50/207

(52) U.S. Cl. CPC H01M 50/244; C09J 5/06; C09J 11/04; H01M 50/207

(57) ABSTRACT

A main object of the present disclosure is to provide a method for producing a battery pack capable of efficiently curing an adhesive while suppressing a single battery from being heated. The present disclosure achieves the object by providing a method for producing a battery pack, the method comprising steps of: a preparing step; a storage step; and a filling step, wherein the preparing step is a step of preparing a laminated battery having a plurality of single batteries laminated in a thickness direction, the storage step is a step of storing the laminated battery in a battery case, the filling step is a step of fixing the laminated battery to the battery case by filling an adhesive in the battery case, wherein the adhesive contains a main agent, a curing agent, and a filler, the filling step includes a discharge process for discharging the adhesive from a nozzle and a heat treatment for heating the adhesive discharged from the nozzle by irradiating infrared rays, and the infrared rays are irradiated to the adhesive in the middle of discharge.

### TECHNICAL FIELD

The present disclosure relates to a method for producing battery pack and battery pack.

### BACKGROUND

Battery packs are known in which a plurality of single batteries is housed and the single batteries are fixed to the battery case by an adhesive. In addition, methods for manufacturing such battery packs are known.

For example, Patent Literature 1 discloses a battery pack in which the inner surface of the case and the outer surface of the element battery are bonded to each other by a reactive hot melt to fix the element battery. In addition, Patent Literature 2 discloses a battery pack including a battery layered product in which a plurality of batteries is arranged, a case in which a battery layered product is accommodated, and thermally conductive layers composed of a battery layered product and a thermally conductive thermosetting adhesive filled in a gap between the cases. Further, although not directly related to method for producing of battery pack, Patent Literature 3 discloses a resin-filling process in which the coils constituting the motor are molded with resin and integrally sealed. In Patent Literature 3, a current is applied to the coil to cause the coil to generate heat, and the coil is filled with resin.

### CITATION LIST

### Patent Literatures

Patent Document 1: Japanese Patent Application Laid-Open (JP-A) No. 2000-243364
Patent Literature 2: JP-A No. 2021-140914
Patent Literature 3: JP-A No. 2020-092521

### SUMMARY OF DISCLOSURE

### Technical Problem

When manufacturing a battery pack, it is assumed that a battery case containing a single battery is filled with an adhesive, and the single battery is fixed to battery case by the cured adhesive. Here, in the case where the adhesive is a so-called two-part curable adhesive containing a main agent and a curing agent, it is assumed that the adhesive is heated to accelerate the curing. On the other hand, when an electrode layer of the single battery is heated by the heating of the adhesive, battery performance may deteriorate.

The present disclosure has been made in view of the above circumstances, and it is a main object of the present disclosure to provide a method for producing a battery pack capable of efficiently curing an adhesive while suppressing a single battery from being heated.

### Solution to Problem

[1]

A method for producing a battery pack, the method comprising steps of: a preparing step; a storage step; and a filling step, wherein the preparing step is a step of preparing a laminated battery having a plurality of single batteries laminated in a thickness direction, the storage step is a step of storing the laminated battery in a battery case, the filling step is a step of fixing the laminated battery to the battery case by filling an adhesive in the battery case, wherein the adhesive contains a main agent, a curing agent, and a filler, the filling step includes a discharge process for discharging the adhesive from a nozzle and a heat treatment for heating the adhesive discharged from the nozzle by irradiating infrared rays, and the infrared rays are irradiated to the adhesive in the middle of discharge.

[2]

The method for producing a battery pack according to [1], wherein the filler is at least one of a black pigment and a black ceramic.

[3]

The method for producing a battery pack according to [1] or [2], wherein the heat treatment is a treatment in which the temperature of the adhesive is heated from room temperature to 40° C. or higher.

[4]

A battery pack having a laminated battery and a battery case, wherein the laminated battery is housed in the battery case, the laminated battery has a plurality of single batteries laminated in a thickness direction, the laminated battery is fixed to the battery case by an adhesive, and the adhesive contains a main agent, a curing agent, and a filler.

[5]

The battery pack according to [4], wherein the filler is at least one of a black pigment and a black ceramic.

### Advantageous Effects of Disclosure

According to the present disclosure, it is possible to efficiently cure the adhesive while suppressing the heating of the single battery.

### BRIEF DESCRIPTION OF DRAWINGS

FIG. 1A to 1E are schematic diagrams illustrating a method for producing of a battery pack according to the present disclosure.

FIG. 2 is a schematic cross-sectional view illustrating a single battery according to the present disclosure.

FIG. 3 is a schematic cross-sectional view illustrating a battery case according to the present disclosure.

FIG. 4 is a schematic perspective view illustrating the shape of a nozzle in the present disclosure.

### DESCRIPTION OF EMBODIMENTS

Hereinafter, method for producing and battery packs will be described in detail. The figures shown below are examples, and the size of each part and the shape of each part may be exaggerated for ease of understanding.

### A. Method for Producing Battery Pack

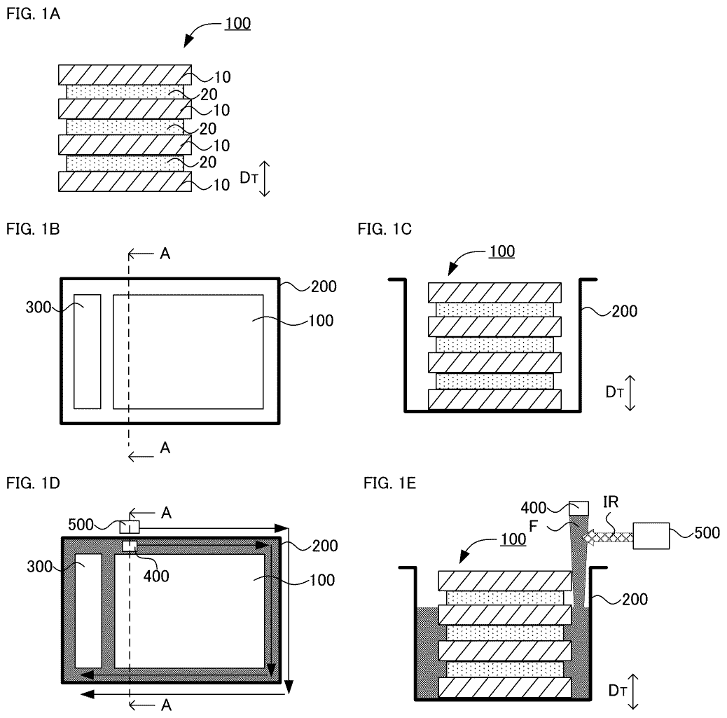

FIG. 1 is a schematic diagram illustrating a method for producing according to the present disclosure. Specifically, FIG. 1A is a schematic side view illustrating a laminated battery prepared in a preparing step. FIG. 1B is a schematic plan view illustrating a housing step. FIG. 1C is a A-A cross-sectional view of FIG. 1B. FIG. 1D is a schematic plan view illustrating a filling step. FIG. 1E is a A-A cross-sectional view of FIG. 1D.

As shown in FIG. 1A, in method for producing disclosed herein, first, a stack battery 100 having a plurality of single battery 10 laminated on a thickness-direction Dr is prepared (preparing step). Next, as shown in FIGS. 1B and 1C, layered product 100 is accommodated in battery case 200 (accommodation step). Then, as shown in FIGS. 1D and 1E, battery case 200 is filled with the adhesive F, and the laminated battery 100 is fixed to battery case 200 (filling step). The adhesive F contains a main agent, a curing agent, and a filler. The filling process includes a predetermined discharge process and a predetermined heat treatment. As illustrated in FIGS. 1D and 1E, the discharge process is a process of discharging the adhesive F from the nozzle 400. Further, the heat treatment is a treatment in which the adhesive F discharged from the nozzle 400 is heated by irradiating with an infrared-ray IR. As illustrated in FIG. 1E, the infrared-ray IR is applied to the adhesive F during ejection.

According to the present disclosure, the adhesive being discharged is irradiated with infrared rays to heat the adhesive. Therefore, it is possible to efficiently cure the adhesive while suppressing the single battery from being heated.

For example, when the adhesive filled in battery case is heated, it is assumed that the entire battery case is heated. In this regard, the laminated battery accommodated in battery case may also be heated, and the layers of battery may deteriorate. Moreover, such a heating method is not efficient in terms of heat capacity.

On the other hand, in the method of the present disclosure, only the adhesive can be heated by infrared rays. Therefore, the adhesive can be efficiently heated and cured. In addition, the adhesive in the present disclosure contains a filler. Since the filler absorbs infrared rays, the heating of the adhesive can be accelerated. Further, in the method of the present disclosure, infrared rays are applied to the adhesive in the middle of ejection. Therefore, it is possible to prevent the single battery from being directly irradiated with infrared rays and to prevent the single battery from being heated. In addition, even when a battery case that does not transmit infra-red rays is used, the adhesive can be efficiently heated. Furthermore, since infrared rays are used, there is no risk of scattering of the adhesive.

### 1. Preparing Step

Preparing step is a step of preparing a stack battery having a plurality of single battery laminated in the thickness direction.

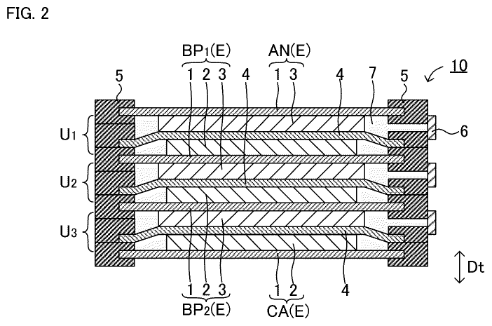

FIG. 2 is a schematic cross-sectional view illustrating a single battery according to the present disclosure. As shown in FIG. 2, the single battery 10 typically has an electrode-E. The electrode E has a current collector 1 and an electrode layer (cathode active material layer 2 or anode active material layer 3). The electrode-layer is arranged on at least one surface of current collector 1 in the thickness-direction D_{T}. As shown in FIG. 2, the single battery 10 may have a bipolar electrode BP as the electrode E. The bipolar BP comprises cathode active material layers 2 arranged on one side of current collector 1. The bipolar BP also comprises anode active material layers 3 arranged on the other side of current collector 1 in thickness. Note that the single battery in the present disclosure does not have to have a bipolar electrode.

The single battery 10 shown in FIG. 2 has a bipolar electrode (BP₁ and BP₂), an cathode end electrode CA, and a anode end electrode AN as the electrode E. The bipolar electrodes are as described above. Cathode end-electrode CA comprises a current collector 1 and cathode active material layers 2 arranged on one side of current collector 1. Anode end-electrode AN comprises a current collector 1 and anode active material layers 3 arranged on one side of current collector 1. Although not shown in the drawings, the single battery is usually sealed with a exterior body such as a laminated film.

Further, as shown in FIG. 2, the single battery 10 typically includes a power generation unit U (U1, U2, U3). The power generation unit U includes a cathode active material layer 2, a anode active material layer 3, and separators (electrolyte layers) 4. The separators 4 are arranged between cathode active material layers 2 and anode active material layers 3. The power generation unit U shown in FIG. 2 is sealed by the seal member 5 and the cover member 6. The inside of the power generation unit U is filled with an electrolytic solution 7. Consequently, cathode active material layers 2, anode active material layers 3, and the separators 4 are each impregnated with an electrolyte solution. The single battery may have one power generation unit or two or more power generation units.

Current collector (cathode current collector and anode current collector) may be a conventionally known member. The electrode layers (cathode active material layers and anode active material layers) may be conventionally known members. The separator may be a conventionally known member.

The single battery may be a all solid state battery that contains solid electrolyte as an electrolyte. The single battery may be a liquid-based battery that contains a liquid-based electrolyte as an electrolyte. The single battery is typically a lithium-ion battery.

A planar shape (a shape viewed from the thickness direction) of the single battery is, for example, a square or a rectangle.

The lengths of the respective sides constituting the planar shapes of the single battery are, for example, 30 cm or more. The length of the side may be greater than or equal to 60 cm or greater than or equal to 100 cm. On the other hand, the length of the side is, for example, 200 cm or less.

In the laminated battery, the number of single battery is 2 or more. The number of single battery may be 3 or more, 5 or more, or 10 or more. On the other hand, the number of single battery is, for example, 50 or less.

As illustrated in FIG. 1A, layered product 100 may include an intermediate member 20. The intermediate member is disposed between the plurality of single battery stacked in the thickness direction. In battery pack, the intermediate member functions as a cooling member for cooling the single battery.

### 2. Containment Process

The housing step is a step of housing layered product in battery case.

As shown in FIGS. 1B and 1C, in the accommodation step, the laminated battery 100 is usually accommodated with a gap provided between it and the inner surface of battery case 200 (a wall portion of a battery case to be described later). Further, as shown in FIG. 1B, in the housing step, the control device 300 may be housed together with the laminated battery 100 in battery case 200. The control device performs various controls of battery.

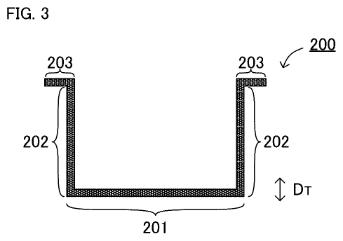

FIG. 3 is a schematic cross-sectional view illustrating a battery case. As shown in FIG. 3, the cross-sectional shape of battery case 200 is generally a concave shape having a bottom portion 201, a wall portion 202, and a flanged portion 203. In addition, “in battery case” can be regarded as a space closer to the bottom portion 201 than the flanged portion 203 in the thickness-direction Dr. The material of battery case is not particularly limited, and may be a conventionally known material.

### 3. Filling Process

The filling step is a step of filling battery case with an adhesive and fixing the laminated battery to battery case. In particular, the filling process in the present disclosure includes a predetermined discharge process and a predetermined heat treatment.

As shown in FIG. 1D, in the filling step, the adhesive is preferably filled so as to surround the entire outer periphery of the laminated battery 100. The amount of the adhesive to be filled is, for example, an amount in which all the single battery in the laminated battery can come into contact with the adhesive.

The adhesive in the filling step contains a main agent and a curing agent. That is, the adhesive is a so-called two-part curing adhesive. The adhesive also contains a filler. Examples of the filler include black pigments and black ceramics. Since the black pigment and the black ceramic have better absorption of infrared rays, the heating of the adhesive can be further accelerated. The adhesive may contain only one of a black pigment and a black ceramic. The adhesive may contain both black pigments and black ceramics. Examples of the black pigment include conventionally known black pigments. Examples of the black ceramics include conventionally known black ceramics. The proportion of the filler in the adhesive is, for example, 5 wt % or more and 50 wt % or less.

Examples of the adhesive include a conventionally known two-component curing type adhesive except that the adhesive contains the above-mentioned filler. Adhesives include epoxy and urethane adhesives.

### (1) Discharge Process

The discharge process is a process of discharging the adhesive from the nozzle. The dispensing process is continued until battery case is filled with a predetermined quantity of adhesive.

As illustrated in FIG. 1E, the nozzle 400 is generally disposed above battery case 200 (above the flange portion 203). Then, the adhesive F is discharged toward the gap between battery case 200 and layered product 100. As shown in FIG. 1D, the adhesive F is preferably discharged while the nozzle 400 is scanned along the gap.

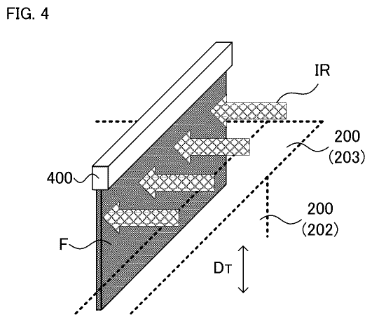

As illustrated in FIG. 4, the nozzle 400 preferably has a shape in which the adhesive F is discharged in a curtain shape. In other words, the nozzle is preferably a curtain-type nozzle. This is because the area irradiated with infrared rays can be increased.

The adhesive is preferably discharged from the nozzle in a condition in which the main agent, the curing agent, and the filler are mixed. Further, the temperature of the adhesive to be discharged is preferably at room temperature. Here, “room temperature” refers to a temperature of 15° C. or higher and 25° C. or lower. The rate at which the adhesive is discharged is, for example, equal to or higher than 5 cc/sec and equal to or lower than 20 cc/sec. Further, it is preferable that the ejection direction (ejection angle) of the nozzle is parallel to the thickness direction. Note that “parallel” does not mean exact parallel only. In other words, “parallel” in the present disclosure does not mean only when the angle formed by the two directions is 0°.

In the present disclosure, “parallel” means that an angle formed by two directions is 0° or more and 30° or less.

### (2) Heat Treatment

The heat treatment is a treatment in which the adhesive discharged from the nozzle is heated by irradiation with infrared rays. In addition, in the heat treatment, the infrared rays are irradiated onto the adhesive in the middle of discharge. “Adhesive during ejection” can be regarded as an adhesive that is not disposed in battery case. For example, as illustrated in FIG. 1E and FIG. 4, in the thickness-direction D_{T}, the adhesive F positioned between the nozzle 400 and battery case 200 (the flanged portion 203 of battery case 200) is irradiated with an infrared IR.

As shown in FIG. 1E, infrared rays are usually emitted from a heat source 500. The heat source may be a condenser lamp or a laser. As shown in FIG. 1D, the heat source 500 may irradiate infrared rays while following the scanning of the nozzle 400.

In the heat treatment, the temperature of the adhesive is preferably heated from room temperature to 40° C. or higher. In the heat treatment, the adhesive may be heated to 50° C. or higher. In the heat treatment, the adhesive may be heated to 60° C. or higher.

The type of infrared ray is not particularly limited. The infrared rays may be near infrared rays, intermediate infrared rays, or far infrared rays. Of these, near infrared rays are preferable.

### B. Battery Pack

Battery pack includes a laminated battery and a battery case. The laminated battery is housed in battery case. The stacked battery includes a plurality of single battery stacked in a thickness direction. The laminated battery is fixed to battery case by an adhesive. The adhesive contains a main agent, a curing agent, and a filler. In addition, battery may have a lid for sealing battery case filled with the adhesive.

The laminated battery, battery case, and the adhesive are as described above. Further, the lid may be a conventionally known material.

The use of battery pack is not particularly limited. Battery pack can be used to power vehicles. Vehicles include, for example, hybrid electric vehicle (HEV), plug-in hybrid electric vehicle (PHEV), battery electric vehicle (BEV), gasoline-powered vehicles, and diesel-powered vehicles. It is particularly preferred that battery pack is used for a power supply for driving a hybrid electric vehicle (HEV) or a plug-in hybrid electric vehicle (PHEV) or a battery electric vehicle (BEV). Battery pack may be used as a power source for mobile objects other than vehicles (e.g., railroads, ships, airplanes). Battery may be used as a power source for an electric device such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### REFERENCE SINGS LIST

1 Current collector
2 Cathode active material layers
3 Anode active material layers
4 Separator
E Electrode
10 Single battery
100 Laminated battery
200 Battery case
300 Control equipment
400 Nozzle
500 Heat source

What is claimed is:

1. A method for producing a battery pack, the method comprising steps of: a preparing step; a storage step; and a filling step, wherein the preparing step is a step of preparing a laminated battery having a plurality of single batteries laminated in a thickness direction, the storage step is a step of storing the laminated battery in a battery case, the filling step is a step of fixing the laminated battery to the battery case by filling an adhesive in the battery case, wherein the adhesive contains a main agent, a curing agent, and a filler, the filling step includes a discharge process for discharging the adhesive from a nozzle and a heat treatment for heating the adhesive discharged from the nozzle by irradiating infrared rays, and the infrared rays are irradiated to the adhesive in the middle of discharge.

2. The method for producing a battery pack according to claim 1, wherein the filler is at least one of a black pigment and a black ceramic.

3. The method for producing a battery pack according to claim 1, wherein the heat treatment is a treatment in which the temperature of the adhesive is heated from room temperature to 40° C. or higher.

4. A battery pack having a laminated battery and a battery case, wherein the laminated battery is housed in the battery case, the laminated battery has a plurality of single batteries laminated in a thickness direction, the laminated battery is fixed to the battery case by an adhesive, and the adhesive contains a main agent, a curing agent, and a filler.

5. The battery pack according to claim 4, wherein the filler is at least one of a black pigment and a black ceramic.
